(19) United States
(12) Patent Application Publication
(10) Pub. No.: US 2026/0030000 A1
(43) Pub. Date: Jan. 29, 2026

(54) AUTOMATIC GENERATION OF INFRASTRUCTURE-AS-CODE

(71) Applicant: HEWLETT PACKARD ENTERPRISE DEVELOPMENT LP, Spring, TX (US)

(72) Inventors: Lorenzo Blasi, Malnate (VA) (IT); Laurentiu Constantin Niculut, Rome (RM) (IT); Debora Benedetto, Rome (RM) (IT)

(21) Appl. No.: 18/787,576

(22) Filed: Jul. 29, 2024

(51) Int. Cl. G06F 8/36; G06F 40/205

(52) U.S. Cl. CPC G06F 8/36; G06F 40/205

(57) ABSTRACT

An infrastructural code generator comprises a template library, a parser, and a code generator subsystem. The template library stores multiple infrastructure-as-code (IaC) templates, each comprising IaC code fragments and placeholders. The parser generates an intermediate representation comprising keywords by parsing a received infrastructure definition file. The code generator subsystem generates an output IaC code file from the intermediate representation. The output IaC code file is generated by (1) selecting at least one of the IaC templates and substituting the keywords from the intermediate representation for the placeholders in the selected IaC template to generate new IaC code, and (2) in response to the infrastructure definition file comprising an assets folder containing preexisting IaC code, integrating the preexisting IaC code with the new IaC code to generate the output IaC code file.

### GOVERNMENT CONTRACTS

The project leading to this application has received funding from the European Union's Horizon 2020 research and innovation programme under grant agreement No 101000162.

### INTRODUCTION

Infrastructure-as-code (IaC) refers to using code—i.e., machine readable instructions—to provision, configure, deploy, and/or orchestrate information processing infrastructure in a cloud or composable information processing system, rather than a user manually entering settings into the user interface of the cloud/composable system. To provision infrastructure via IaC, a user may write code in a particular IaC programming language, with the code specifying the type of infrastructure to be provisioned and the relevant settings and other attributes thereof. This code, referred to herein as IaC code, may then be provided to an IaC tool which can read the IaC programing language, such as Terraform or Ansible, and the IaC tool interprets the IaC code and automatically interacts with the target system to cause the system to provision the infrastructure specified by the IaC code. Thus, the IaC approach allows for at least part of the provisioning, configuration, deployment, and/or orchestration of the infrastructure to be automated. IaC may allow for infrastructure to be provisioned in a more efficient, repeatable, and controlled manner as compared to manually provisioning the infrastructure.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 is a block diagram illustrating an example computing system.

FIG. 2 is a block diagram illustrating components of the computing system of FIG. 1.

FIG. 3 is a block diagram illustrating portions of one implementation example of the computing system of FIG. 1.

FIG. 4 is a schematic diagram of a directed acyclic graph usable by the computing system of FIG. 1.

FIG. 5 is a schematic diagram of traversal of the directed acyclic graph of FIG. 4.

FIG. 6 is a process flow chart illustrating an example method.

FIG. 7 is a block diagram illustrating an example non-transitory computer readable medium.

### DETAILED DESCRIPTION

While IaC may be preferable to manually provisioning infrastructure in many instances, IaC can be difficult to use and inconvenient in some circumstances. Each IaC tool may have its own unique IaC programming language that a user must learn before they can generate usable IaC code. Many organizations lack personnel who have such specialized knowledge of IaC languages, and thus the organization might not be able to use IaC without investing significantly (both time and money) in training personnel to be able to write IaC code or hiring new personnel. This difficulty is multiplied if the organization desires to utilize multiple different IaC tools or to change IaC tools over time, as each tool has its own IaC language that will need to be learned. Furthermore, even if one knows the relevant IaC language, the actual writing of the IaC code itself can be difficult and prone to error, with the difficulty increasing with the complexity of the infrastructure being deployed. Often, IaC code includes many lines of code—in some cases, thousands of lines—and thus writing IaC code can be a time consuming and challenging task with ample opportunities for human error.

To address these issues, the present disclosure provides an Infrastructural Code Generator (ICG), which is a tool that can automatically generate IaC code in any of a variety of IaC languages based on simplified user input. A user can input to the ICG a model which represents the infrastructure to be deployed in simplified terms, as well as other information, such as an identification of the desired IaC language for the generated IaC code and an identification of the target system (e.g., cloud provider) for the deployment, and based on this information the ICG automatically generates IaC code in the appropriate IaC language. In some examples, the model which represents the infrastructure to be deployed may be formed from an infrastructure modeling language, such as the DevSecOps Modelling Language (DOML). By using the ICG the user can obtain IaC code without actually having to know or write in any IaC programming language. In addition, the information the user specifies in the model which is fed to the ICG may be much simpler than the IaC code itself, making it much easier for a user to generate the IaC code via the ICG than by manually writing the IaC code, even if the user has expertise in the relevant IaC language.

In some examples, ICG may use a template-based code generation technique to transform the input data of the received model into structured text forming IaC code of the appropriate IaC programming language. A variety of templates may be stored in the system, with each including code fragments written in a corresponding IaC language with placeholders interspersed through the code. The ICG parses data input from a user and generates an intermediate representation which has keywords from the user input data and other related information (such as the target IaC language and the target cloud system). Based on the information in the intermediate representation, the ICG can select the appropriate template to use. The ICG then substitutes the keywords for the placeholders in the template, with the resulting structured text being a fully executable IaC code block in the target language. An IaC code file may then be output comprising one or more of these IaC code blocks, and this IaC code can then be fed to a corresponding IaC tool (such as Terraform, Ansible, etc.) to create the infrastructure. In this manner, a user can generate IaC code much more easily than writing it manually and without having to be an expert in any given IaC language.

In some examples, the ICG may also allow a user to include an assets folder in the infrastructure model which they input into the ICG. In this assets folder, the user can store preexisting IaC code, which may have been previously written manually, generated by ICG for some other project, or obtained from some other source. In cases where a user does include preexisting IaC code in the assets folder, ICG may integrate that preexisting code with the new IaC code being generated by ICG according to the processes described above, so that the resulting output IaC code file comprises a combination of the new IaC code and the preexisting IaC code. This can allow for seamless integration of ICG with an organization's existing IaC assets. This can also allow for more efficient development of IaC, as effort is not wasted duplicating existing assets.

As noted above, ICG may generate code compatible with multiple different IaC tools. In some examples, these tools include Terraform and Ansible. In some examples, the tools also include Docker Compose. In addition, in some examples, ICG may be structured in a way that allows it to be easily expandable to accommodate other IaC tools. For example, in some implementations ICG utilizes code generator plugins for each IaC tool for which it can generate code. ICG may chose the appropriate plugin to use based on the desired IaC language specified by the user, and then the selected plugin selects the templates to use and substitutes the keywords from the intermediate representation for the placeholders in the template. Thus, support for a new IaC tool can be easily added to ICG by adding appropriate templates to the template library and adding a corresponding code generator plugin which can select those templates and perform the substitution. In this manner, ICG can be highly flexible and easily expandable.

As noted above, in some examples ICG is configured to generate IaC for use by Docker Compose. Docker Compose is used to form containers, which may present certain special challenges. In particular, often when infrastructure which utilizes containers is deployed, multiple containers may be included in the deployment. Moreover, these containers sometimes have dependencies, meaning that one container will not deploy properly unless another container has already been deployed. In other words, there is sometimes a correct order in which the containers need to be deployed. Accordingly, if an IaC code file merely includes code blocks for deploying the needed containers, it is possible that the containers could be deployed out of order, which could cause errors in the deployment. To avoid these problems, ICG may be configured to specify an appropriate order of execution for IaC code blocks (in particular, IaC code blocks for instantiating containers). For example, the output IaC code file may include in it a configuration file in which the proper order of execution is specified.

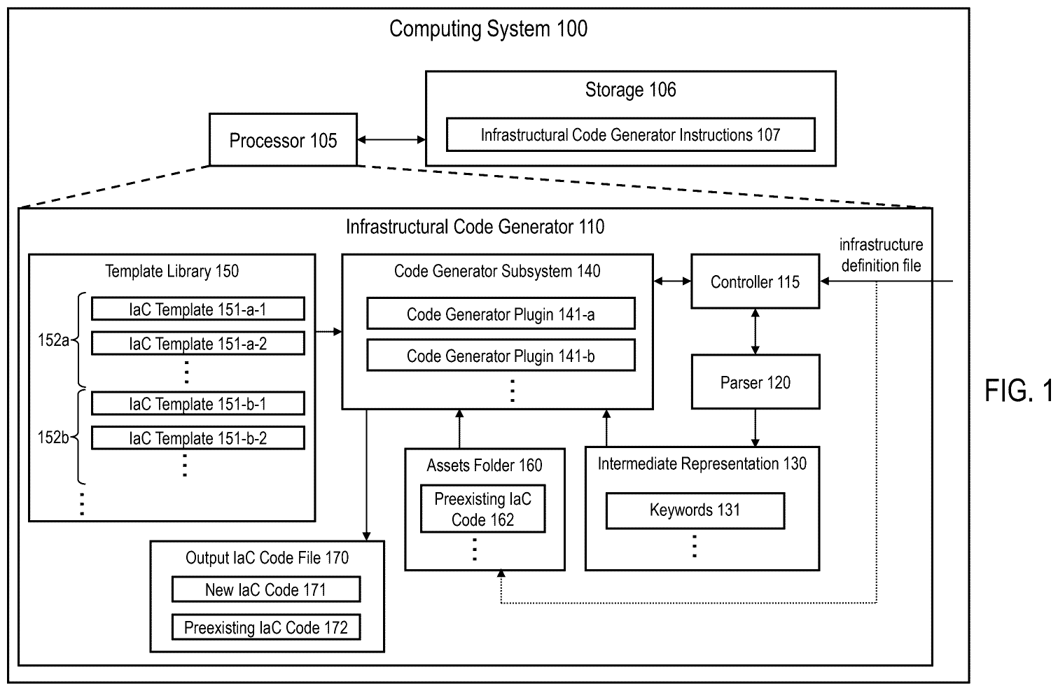

These and other examples will be described in greater detail below in relation to FIGS. 1-7.

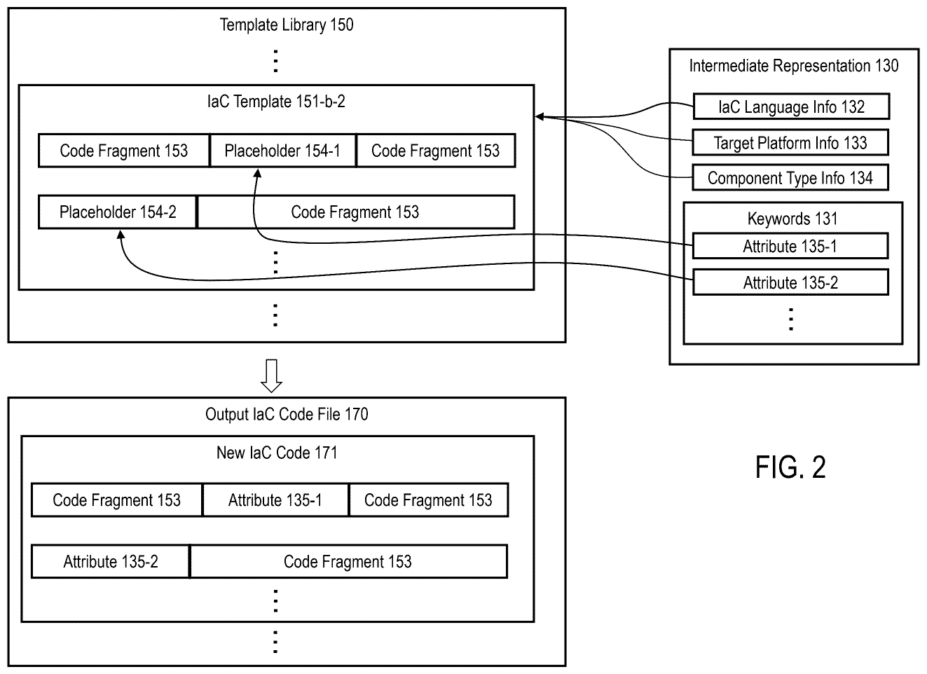

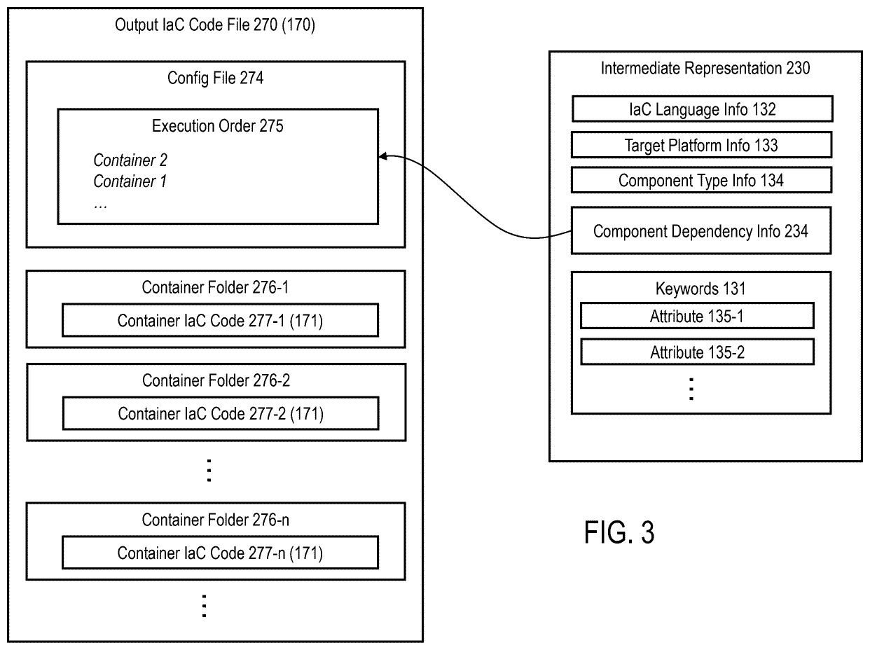

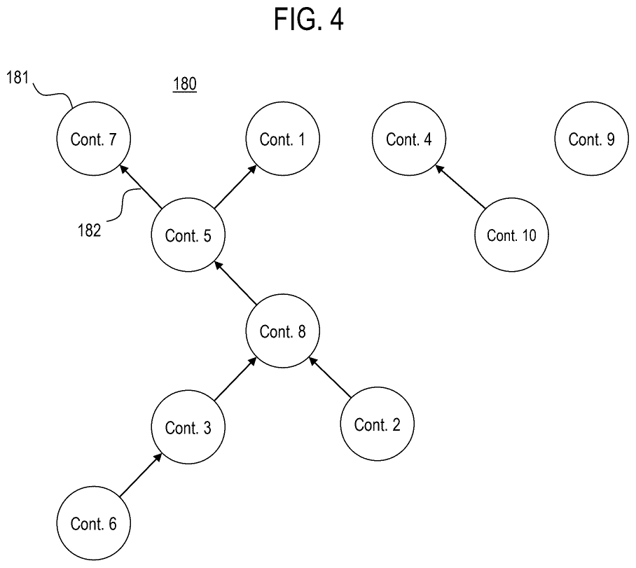

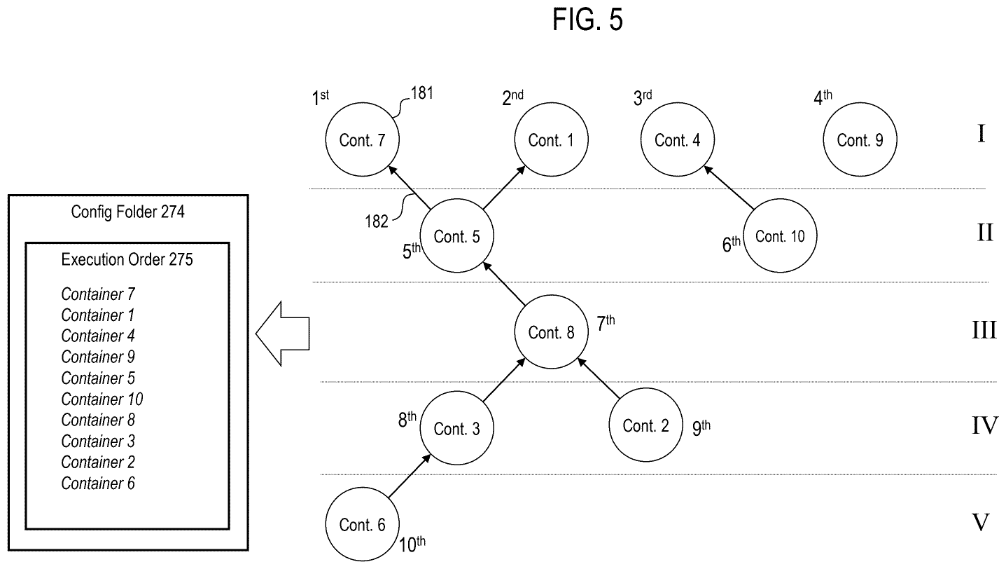

FIG. 1 illustrates an example computing system 100. FIG. 2 illustrates certain components of the system 100 in greater detail. FIG. 3 illustrates portions of an example implementation of the system 100. FIG. 4 illustrates a direct acyclic graph (DAG) which may be used by the system 100 in certain implementations. FIG. 5 illustrates a process of the system 100 visiting the (DAG) of FIG. 4 to generate an execution order. FIGS. 1-5 are schematic in nature and are not intended to illustrate shapes, sizes, or other structural details accurately or to scale. Components which are not illustrated in FIGS. 1-5 may also be included in some examples disclosed herein, or one or more components illustrated in FIGS. 1-5 may be omitted from some examples disclosed herein. In FIG. 1, communications or communications pathways are indicated conceptually by arrows.

As shown in FIG. 1, the system 100 comprises a processor 105 and a data storage unit 106 (storage 106) configured to instantiate an infrastructural code generator 110.

The processor 105 may be any information processing resource, such as a central processing unit (CPU), a graphical processing unit (GPU), a system-on-chip (SoC), an application-specific integrated circuit (ASIC), or any other hardware capable of processing machine readable information. Although only one processor 105 is illustrated in FIG. 1 and references herein to the processor may be in singular form, this is merely for convenience of description and it should be understood that the processor 105 may include multiple devices which may work together to perform operations described herein.

The data storage unit 106 may include any data storage device configured to store information in a non-transitory and machine readable manner, such as a hard-disk drive (HDD), solid-state drive (SSD), non-volatile memory device, or the like. In some examples, data storage unit 106 may also include volatile memory devices to temporarily store data during operation, such as Random Access Memory (RAM). The storage 106 stores infrastructural code generator instructions 107.

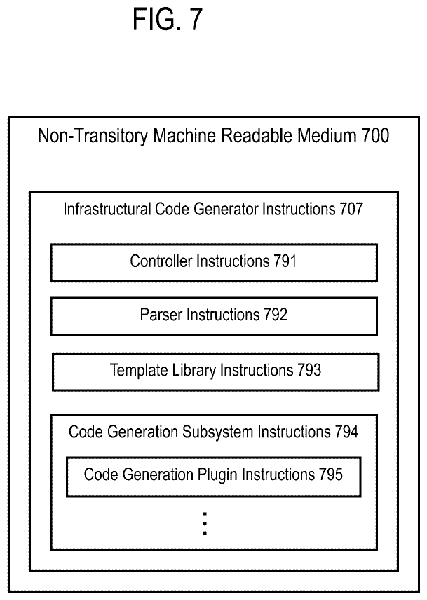

The processor 105 is communicably connected to the storage 106 and configured to, during operation of the system 100, retrieve and execute the infrastructural code generator instructions 107. The infrastructural code generator instructions 107 are configured to, when executed by the processor 105, instantiate and run the infrastructural code generator 110 (ICG 110). Note that the ICG 110 may not be actively instantiated when the system 100 is not in operation, but because the instructions 107 for instantiating the ICG 110 are present in the system 100 even when the system 100 is not in operation, the ICG 110 may be regarded as being logically present and a component of the system 100 even when the system 100 is not in operation. Moreover, for each of the components of the ICG 110 there may be a corresponding set of machine-readable instructions that are executable by the processor 105 to cause the processor 105 to instantiate the component and to perform the operations associated with that component, and these sets of instructions may be part of the instructions 107. In other words, although not labeled as “instructions” herein, the components of the ICG 110 may be embodied by corresponding instructions which together make up the instructions 107 (for example, see FIG. 7, described below, which illustrates instructions 707 which are one example implementation of the instructions 107).

As shown in FIG. 1, the ICG 110 comprises a controller 115, a parser 120, a code generator subsystem 140, and a template library 150 storing IaC templates 151. The ICG 110 also generates, receives, and/or stores various files or other data structures, including an infrastructure definition file, an intermediate representation 130, an assets folder 160, and an output IaC code file 170. These components of the ICG 110 will be described in turn below.

The controller 115 is configured to receive an infrastructure definition file. The infrastructure definition file may include a simplified or abstracted description of the infrastructure to be deployed. This description may include information such as: identifications of the types of components to be deployed (e.g., virtual machines (VMs), containers, bare-metal servers, etc.), identifications of attributes of the components (e.g., a name for a VM, an operating system to be included in the VM, an amount of memory to allocate to the VM, etc.), identification of a desired IaC language for the output IaC code, and identification of a target platform on which the infrastructure will be deployed (e.g., a target public cloud provider, a target private cloud system, a target composable system, etc.). In some examples, the description may also include identification of applications or other software components which are to be installed on the other infrastructure components. This simplified/abstracted description of the infrastructure may be referred to herein as a “model” of the infrastructure.

In some examples, the infrastructure definition file may have a predefined format defined according to an infrastructure modeling language specification. For example, DOML is an infrastructure modeling language defined by the PIACERE project which can be used to create models of infrastructure which are referred to as DOML models. In some examples, the ICG 110 is configured to accept such DOML models as the input infrastructure definition files. In some examples, infrastructure models generated using other infrastructure modeling languages may be accepted by ICG 110 as the input infrastructure definition files (in addition to or in lieu of accepting DOML models). In some examples, a specifically defined infrastructure modeling language is not required and the system may be able accept input infrastructure definition files having an arbitrary format, such as a simple text file generated by a general purpose text editor (in addition to or in lieu of accepting DOML models or other models). However, it should be noted that it may be difficult to parse some files in arbitrary formats, and thus in some examples the ICG 110 may be limited to receiving models of a predefined format to make it easier to parse the files.

In examples which utilize DOML models as the infrastructure definition file, the DOML model may have a three-layered structure, with software components being defined in an application layer, infrastructure components being defined in an infrastructure layer, and concretizations of the infrastructure components to specific technologies (e.g., to specific cloud providers/composable systems, to specific services thereof, etc.) being defined in a concretizations layer. This layered approach allows for a user to more easily switch from one technology to another or change the infrastructure on which the applications are deployed by simply changing the relevant section of the DOML model.

Below in Table 1 is one example of a hypothetical DOML model. This example DOML model is for deploying a container running an nginx application. As specified in the infrastructure layer of the example DOML model, the container is to be named “co1” and is to be hosted on “vm1,” with co1 being generated from the image “nginx” obtained at “hub.docket.com/_/nginx”. Furthermore, the DOML model specifies that vm1 has a Cent-OS operating system, is allocated two CPUs, 8 GB of RAM, and 40 GB of disk space, and has communication interface i1 of network net1. In the concretizations layer, it is specified that vm1 is to be hosted on an Openstack cloud platform. Note that in this example, there is no application layer included in the DOML model because the nginx container image already contains the desired nginx application and no further application specification is needed. However, in other examples the DOML model may include an application layer specifying applications.

### Table 1

doml Nginix_on_Openstack
{
   Infrastructure infra {
      cont_image nginx {
         image “hub.docket.com/_/nginx”
         generates co1
      }
      container co1 {
         host vm1
      }
      vm vm1 {
         os “CentOS-7-2111”
         cpu_count 2
         mem_mb 8192.0
         iface i1 {
         belongs_to net1
         }
      }
      Net net1 {
         cidr “/24”
         protocol “tcp/ip”
      }
      sto disk0 {
         label “disk0”
         size_gb 40
      }
   }
   Concretizations {
      concrete_infrastructure con_infra {
         provider openstack {
         vm nginx_host {
         maps vm1
         {
         net nginx_net {
         cidr “16.0.0.0/16”
         maps net1
         }
         }
      }
      active con_infra
   }
}

Note that the DOML model is a fairly simple and abstract description of the infrastructure. Moreover, the model allows the format for describing the infrastructure components to be standardized across all platforms (e.g., cloud providers) and across all IaC languages. This can allow, for example, a user to describe a virtual machine to be created using the same standard descriptive format regardless of which platform the vm will ultimately be provisioned on and regardless of the IaC coding language that will ultimately be used to effectuate the provisioning. In contrast, if the user were to manually write IaC code to create the same virtual machine, different IaC code may be needed for each unique combination of platform and IaC language, thus requiring the user to be versed in many different code formats and to select the right one for the situation at hand. This is much more difficult and complicated than learning one single modeling language which can be used for many combinations of platforms and IaC languages. Furthermore, in addition to the benefits of using a standardized descriptive format which is not unique to particular platforms or IaC languages, the DOML model may also be preferable to manually writing IaC code in that the information entered into the DOML model may be much briefer and simpler than the IaC code. For example, in the DOML model in Table 1, the storage “dsik0” is defined very simply by specifying the name and size, whereas to provision the same storage manually may require much more lengthy and complicated code. The DOML model abstracts away most of this complexity and allows the user to simply describe the attributes of the infrastructure objects textually.

The DOML model may be generated in human-readable text form, an XML-based representation, or any other desired format. In some examples, controller 115 is configured to receive an XML-based DOML model.

In some examples, the ICG 110 may be configured to allow the infrastructure definition file to include an assets folder 160. In this assets folder 160 the user can store preexisting IaC code 162, which may have been previously written manually, generated by ICG 110 for some other project, or obtained from some other source. The purpose of this folder 160 will be described in greater detail below.

In some examples, the infrastructure definition file may be imported into ICG 110, with the file having been generated outside of ICG 110 in a separate program or system. In some examples where a separate program is used to generate the infrastructure definition file, the separate program may be completely independent from ICG 110 and the user may need to manually import the file into ICG 110. In other examples where a separate program is used to generate the infrastructure definition file, the separate program and the ICG 110 may be configured to automatically cooperate together, for example to allow for infrastructure definition files generated by the separate program to be accessed directly by ICG 110 and/or to be automatically imported into ICG 110. In some examples, the infrastructure definition file may be created within the ICG 110 itself, rather than by a separate program. In such examples in which ICG 110 creates the infrastructure definition file, ICG 110 may include a file definition program (not illustrated) configured to provide a user interface to allow a user to create the infrastructure definition file directly in ICG 110.

In some examples, the program which generates the infrastructure definition file (whether provided as a separate program or as part of the ICG 110) can be as simple as a general-purpose text editor which allows a user to manually write out text which makes up the infrastructure definition file, without the program necessarily being tailored specifically to creating infrastructure definition files. In other examples, the program which generates the infrastructure definition file (whether provided as a separate program or as part of the ICG 110) may be tailored specifically to generating infrastructure definition files such that the program provides more structure to the file definition process (e.g., providing pre-populated text, providing pre-defined formatting, providing prompts to assist the user, providing fields in which a user can enter information, etc.) and/or the program performs some processing on the data entered by a user (such as converting raw text entered by a user into a format compatible with an infrastructure modeling language). An example of a program specifically tailored to creating infrastructure definition files is the IDE program provided by the PIACERE project. The IDE program may generate DOML models which may be used as the infrastructure definition files in some examples. In some examples, the IDE program may be used separately from the ICG 110 and the resulting DOML models may be manually imported into ICG 110 by the user when the user desires to generate IaC code from the models. In other examples, the IDE program and ICG 110 may be configured to cooperate together such that DOML models generated by IDE are automatically accessible to ICG 110. In still other examples, the IDE program (or a similar program) may be included within ICG 110 as a subroutine or module thereof to allow for generation of the DOML models directly within ICG 110.

In response to receiving the infrastructure definition file (e.g., DOML model), the controller 115 may activate the parser 120 and cause the parser 120 to parse the infrastructure definition file. The parser 120 parses the infrastructure definition file and generates therefrom an intermediate representation 130, as shown in FIG. 1. The intermediate representation 130 is a data structure which includes information gleaned from the infrastructure definition file, including keywords 131. The keywords 131 may come from information specified in the infrastructure definition file, such as names or other attributes of the infrastructure components. For example, in an intermediate representation 130 generated from the example DOML model of Table 1, the keywords 131 may include the container name (“co1”), the VM name (“vm1”), the VM RAM allocation (“8192.0”), etc.

The intermediate representation 130 may also include additional information beyond the attributes of the infrastructure components. For example, as shown in FIG. 2, the intermediate representation 130 may also include IaC language information 132, target platform information 133, and/or component type information 134. Some of this information may also be gleaned from parsing the infrastructure definition file, while others of this information can be gleaned from other sources, such as other user inputs.

The IaC language information 132 specifies the desired IaC language for the IaC code to be generated. In some examples, this information may be gleaned from the infrastructure definition file (i.e., the user may specify an IaC language, or an IaC tool, in the infrastructure definition file). In other examples, the IaC language information 132 may be obtained from some other source. For example, a user may specify the IaC language as a input outside of the file, such as when loading the infrastructure definition file or when activating the ICG 110. ICG 110 may, in some examples, query the user as to which IaC language is desired. As another example, the parser 120 may be configured to use a default IaC language in the absence of instructions to the contrary (the default language may be predefined and unalterable in some cases, user defined in other cases, or predefined but user-alterable in other cases).

The target platform information 133 specifies the platform upon which the infrastructure is to be deployed, such as a target public cloud provider, a target private cloud system, a target composable infrastructure system, etc. This information 133 may be gleaned from the infrastructure definition file in some examples. For example, the DOML model includes the concretizations layer in which the target platform is specified.

The IaC component type information 134 may include information specifying types for each infrastructure component or object which is part of the overall infrastructure being deployed. Types of infrastructure components/objects may include, for example, a virtual machine (VM) type, a container type, a bare-metal server type, a storage type, a network type, a particular sub-type of one of the forgoing, or some other type of infrastructure component/object. Note that a given infrastructure deployment may include multiple type of infrastructure components, which may be reflected in the model of the infrastructure as model objects. For example, in the hypothetical DOML model of Table 1, the model objects which correspond to different types of infrastructure include a container type (for the container co1), a virtual machine type (for the virtual machine vm1), a storage type (for the storage disk0), and a network type (for the network net1). Thus, when there are multiple types of infrastructure components (model objects) in the infrastructure definition file, the intermediate representation 130 may include multiple instances of the IaC component type information 134 corresponding to these infrastructure components/model objects.

In some examples, the intermediate representation 130 may store the information described above in key/value pairs in a JSON format. In some examples, the intermediate representation 130 may be structured as a sequence of steps, with each of the steps corresponding to what will eventually become a block of IaC code. Each of these “steps” may include information related to one or more corresponding infrastructure components (e.g., objects in the DOML model), and may include one or more key/value pairs specifying this information. In particular, each step may include: (a) one or more key/value pairs specifying type(s) for the corresponding infrastructure object(s), with these key/value pairs being examples of the component type information 134 mentioned above, and (b) one or more key/value pairs specifying specific attributes of the corresponding infrastructure object(s), with these key/value pairs being instances of the attributes 135 mentioned above. In some examples, one or more steps (in some cases, all steps) may also include a key/value pair specifying the target IaC language, which may be instances of the IaC language information 132 mentioned above. In some examples, one or more steps (in some cases, all steps) may also include a key/value pair specifying the target cloud provider, which may be instances of the target platform information 133 mentioned above. In some examples, each of these “steps” may be used to create a distinct block of new IaC code 171, which includes code to provision the corresponding infrastructure component with all of its attributes.

For example, if an intermediate representation 130 in JSON format were generated from the example DOML model of Table 1, this intermediate representation 130 may include one or more steps which (individually or collectively) contain key/value pairs describing, among other things: the container “co1”, the virtual machine “vm1”, the network “net1”, and the storage “disk0”. These one or more steps may include one or more key/value pairs specifying the types of these infrastructure objects (e.g., a “container” type, a “virtual machine” type, a “network” type, and a “storage” type) and one or more key/value pairs specifying attributes of the corresponding objects (e.g., the name of the container (i.e., “co1”), the name of the host for the container (i.e., “vm1”), the name of the vm (i.e., “vm1”), the operating system for the vm (i.e., “CentOS-7-2111”), the memory allocation for the vm (i.e., “8192.0”), and so on). In addition, in this example, one or more of the steps (in some cases, each) may include target platform information 133 specifying an Openstack cloud system, as well as a desired IaC language (in the example of Table 1, the IaC language is not specified in the DOML model, but is instead received through a separate user input; in other examples, the IaC language could be specified in the DOML model or other infrastructure definition file).

After the parser 120 has generated the intermediate representation 130, the controller 115 may activate the code generator subsystem 140 and cause the code generator subsystem 140 to generate an output IaC code file 170 from the intermediate representation 130. The code generator subsystem 140 first selects at least one of the IaC templates 151 from the template library 150 based on information from the intermediate representation 130, as will be described in greater detail below. The code generator subsystem 140 then substitutes keywords 131 from the intermediate representation 130 for placeholders in the selected IaC template 151 to generate new IaC code 171. In cases where the assets folder 160 with preexisting IaC code 162 is provided with the infrastructure definition file, the code generator subsystem 140 may integrate that preexisting code 162 with the new IaC code 171 so that the resulting output IaC code file 170 comprises a combination of the new IaC code 171 and the preexisting IaC code 162. This can allow for seamless integration of ICG 110 with an organization's existing IaC assets. This can also allow for more efficient development of IaC code, as effort is not wasted duplicating existing assets. In cases where no assets folder 160 was provided with the infrastructure definition file (or where no preexisting IaC code 162 is present in the folder), the output IaC code file 170 may comprise just the new IaC code 171.

As shown in FIG. 1, in some examples, the code generator subsystem 140 comprises multiple code generator plugins 141. Each code generator plugin 141 corresponds to a different IaC tool, or in other words to a different IaC language (each IaC tool has its own IaC language). In FIG. 1, IaC tools/languages associated with a code generator plugin or template are indicated by a letter appended to the reference numbers 141 or 151. Specifically, code generator plugin 141-a is associated with a first IaC tool/language, and template library 150 comprises a subset 152a of templates 151 which use this same first IaC language, with the subset 152a comprising templates 151a-1, 151-a-2, and others (not illustrated). The composition of the subset 152a may also be represented herein using the notation {151-a-1, 151-a-2, . . . }. Similarly, the code generator plugin 141-b is associated with a second IaC tool/language, and template library 150 comprises a subset 152b of templates 151 which use this same second IaC language, with the subset 152b comprising templates 151b-1, 151-b-2, and others (not illustrated). The composition of the subset 152b may be represented using the notation {151-b-1, 151-b-2, . . . }.

For example, in some implementations, code generator plugin 141-a is associated with the Terraform tool/language and code generator plugin 141-b is associated with the Ansible tool/language, and in such examples the subset 152a of templates {151-a-1, 151-a-2, . . . } use Terraform programing language while the subset 152b of templates {151-a-1, 151-a-2, . . . } use Ansible programing language.

In some examples, code generator subsystem 140 also comprises another code generator plugin 141 (not illustrated) associated with Docker Compose and the template library 150 comprises another subset 152 of corresponding templates 151 which use Docker Compose programming language.

In some examples, code generator subsystem 140 also comprises additional code generator plugins 141 (not illustrated) associated with additional IaC programs and the template library 150 comprises corresponding templates 151.

Each code generator plugin 141 is responsible for generating new IaC code 171 in the corresponding IaC language. When calling the code generator subsystem 140, the controller 115 may select one of the code generator plugins 141 to use for IaC code generation according to the IaC language information 132 specified in the intermediate representation 130. For example, if the intermediate representation 130 specifies Terraform as the IaC language/tool, then a Terraform code generator plugin 141 may be selected, if the intermediate representation 130 specifies Ansible as the IaC language/tool, then an Ansible code generator plugin 141 may be selected, and so on.

Each code generator plugin 141 may be configured to select one or more IaC templates 151 from the template library 150 out of the corresponding subset 152 of templates 151 which correspond to the same IaC tool/language as the plugin 141. Thus, for example, in FIG. 1, the code generator plugin 141-a may select from the subset 152a of templates {151-a-1, 151-a-2, . . . } which have the same IaC language as the code generator plugin 141-a. Similarly, the code generator plugin 141-b may select from the subset 152b of templates {151-b-1, 151-b-2, . . . } which have the same IaC language as the code generator plugin 141-b.

The code generator plugins 141 may select the IaC template(s) 151 from among their corresponding subset 152 of templates 151 based on information from the intermediate representation 130, including the target platform information 133 and/or component type information 134. More specifically, in some implementations each template 151 may be associated with a particular combination of IaC language, target platform, and one or more infrastructure types. For example, template 151-a-1 may be associated with a first language (e.g., Terraform), a first platform (e.g., Openstack) and a first type of infrastructure (e.g., containers), template 151-a-2 may be associated with the first language, the first platform and a second type of infrastructure (e.g., virtual machines), and so on. When generating IaC code for a particular type (or types) of infrastructure specified in the intermediate representation 130, the code generator plugin 141 may select the template 151 which matches the specified infrastructure type (or types), target platform, and IaC language (in some cases, the matching of the IaC language may be accomplished by selecting from among the appropriate subset 152, which has all the templates 151 of the corresponding language).

As shown in FIG. 2, each template 151 comprises one or more code fragments 153 and one or more placeholders 154. In FIG. 2, there are two placeholders 154-1 and 154-2 interspersed among three code fragments 153, but this is merely one example and a template 151 may have any number and arrangement of such fragments 152 and placeholders 154. The code fragments 153 comprise portions of IaC code written in the IaC language corresponding to the template 151. These code fragments 153, taken together, may be similar to the type of IaC code which could be manually written to provision the type(s) of infrastructure component which corresponds to the template 151 on the particular target platform that corresponds to the template 151, with the exception that in the IaC template 151 some elements of the IaC code are omitted and placeholders 154 are placed there instead. Because of the omitted elements, the code in the template 151 is incomplete and would not work as valid IaC code. The omitted elements may include the particular attributes of the infrastructure object which is the subject of the template 151, such as a component name or other attributes, and the placeholders 154 may thus be positioned in the code fragments 153 at the locations where such object attributes would be expected to be positioned in completed IaC code. In other words, the template 151 may be thought of as a genericized version of IaC code for provisioning a particular type of infrastructure on a particular platform in a particular IaC language, which includes code portions which would be applicable to provisioning any instance of that type of infrastructure, regardless of the specific attributes of the infrastructure, but which replaces code portions which would be applicable only to a particular instance of the infrastructure with placeholders. For instance, using “virtual machines” as an example of a type of infrastructure, the exact IaC code needed to provision a virtual machine on a given platform in a given IaC language may vary from one virtual machine to another because the virtual machines have different attributes. However, among these varying instances of IaC code for provisioning virtual machines on the given platform in the given language, there would be many elements that are common to all instances of the IaC code regardless of the specific attributes of the particular virtual machine being provisioned. It is these shared elements which may make up the code fragments 153 in the corresponding “virtual machine” template 151. Moreover, among these varying instances of IaC code for provisioning virtual machines on the given platform in the given language, there would be certain elements that vary from one instance of the IaC code to the next and which are only applicable the particular virtual machine being provisioned. It is these variable elements which are omitted and replaced with placeholders 154 in the template 151.

When one of the code generator plugins 141 selects a template 151 to generate IaC code, the code generator plugins 141 may generate a new IaC code 171 block which is the same as the IaC template 151 except that in the new IaC code 171 the placeholders 154 are replaced with keywords 131 from the intermediate representation 130. In other words, the code generator plugins 141 creates a duplicate of the template 151 and then replaces the placeholders 154 therein with the keywords 131. (A duplicate is created so as not to destroy or overwrite the template 151, thus allowing the template 151 to be used again later to generate more IaC code). The combination of the code fragments 153 and the keywords 131 in the new IaC code 171 forms a complete and valid IaC code block, which may be executable by an IaC tool to provision the particular type(s) of infrastructure associated with the template 151.

For example, FIG. 2 illustrates one hypothetical case in which the keywords 131 include attributes 135-1 and 135-2 and the Templates 151-b-2 includes the placeholders 154-1 and 154-2. In this examples, code generator plugin 141-b may be selected by controller 115 to generate IaC code because the IaC language specified in the IaC language information 132 of the intermediate representation 130 matches that of code generator plugin 141-b. Code generator plugin 141-b may then select IaC template 151-b-2 out of the corresponding set 152b of IaC templates {151-b-1, 151-b-2, . . . } having the target language because this particular template 151-b-2 matches the target platform specified in the target platform information 133 and the component type specified in the component type information 134. The code generator plugin 141-b then generates the new IaC code 171 by copying the template 151-b-2 and substituting the attribute 135-1 for the placeholder 154-1 and substituting the attribute 135-2 for the placeholder 154-2 in the copy.

In some examples, multiple templates 151 may ultimately be used to generate the output IaC code file 170. For example, the output IaC code file 170 may include multiple blocks of new IaC code 171, and each such block may be generated from a different template 151 (or from multiple applications of the same template 151). In some examples, a block of IaC code 171 may relate to a single infrastructure component, while in other case a block of IaC code 171 may relate to multiple related infrastructure components.

For example, returning to the DOML model of Table 1, in some implementations the intermediate representation 130 generated from the DOML model of Table 1 may include (among other things) a first step for the container co1 and a second step for the virtual machine vm1, and thus two separate blocks of new IaC code 171 may be generated for each of these steps by using two different templates 151. For the first step associated with the container co1, a first IaC template 151 which is associated with the “container” type of infrastructure component (as well as being associated with the “Openstack” platform and the target IaC language) will be used to generate a first block of new IaC code 171 for provisioning the container. This block of IaC code 171 may include, among other things, attributes 135 specifying the name of the container (i.e., “co1”) and the name of the host for the container (i.e., “vm1”), which were substituted for placeholders 154 in the corresponding template 151. For the second step associate with the virtual machine vm1, a second IaC template 151 which is associated with the “virtual machine” type of infrastructure component (as well as the “Openstack” platform and the target IaC language), will be used to generate a second block of new IaC code 171 for provisioning the vm. This block of IaC code 171 may include, among other things, attributes 135 specifying the name of the vm (i.e., “vm1”), the operating system for the vm (i.e., “CentOS-7-2111”), the memory allocation for the vm (i.e., “8192.0”), and all the other attributes of the vm1, as well as other attributes 135 specifying information about other infrastructure components which are related to the vm1, such as the name and other attributes of the network assigned to the vm (i.e., “net1”) and the name and other attributes of the storage assigned to the vm (i.e., “disk0”). These attributes 135 of the vm1 and its related components are substituted for placeholders 154 in the corresponding template 151. In this manner, multiple templates 151 may be selected by the code generator plugin 141 during the creation of the output IaC code file 170, with each resulting in a different block of IaC code 171.

As mentioned previously, in some examples a Docker Compose code generator plugin 141 may be included in the subsystem 140 which may generate IaC code for use by Docker Compose. Docker Compose is used to form containers, which may present certain special challenges in some circumstances. In particular, when infrastructure which utilizes containers is deployed, occasionally multiple containers may be included in the deployment. Moreover, these containers sometimes have dependencies, meaning that one container will not deploy properly unless another container has already been deployed. In other words, there is sometimes a correct order in which the containers need to be deployed. Accordingly, if an IaC code file merely includes blocks of code 171 for deploying the needed containers, it is possible that the containers could be deployed out of order, which could cause errors in the deployment. To avoid these problems, ICG 110 may be configured to specify an appropriate order of execution for blocks of IaC code 171 (in particular, IaC code blocks for instantiating containers).

For example, FIG. 3 illustrates one implementation example of the system 100 in which an order of execution for blocks of IaC code 171 can be specified. This implementation of the system 100 comprises output IaC code file 270, which is one example implementation of output IaC code file 170, as well as intermediate representation 230, which is one example implementation of intermediate representation 130. Other components of the system 100 are omitted from FIG. 3 for ease of understanding, but may be the same as illustrated in FIG. 1.

As shown in FIG. 3, in some examples, the output IaC code file 270 may include a configuration file 274 and a number of container folders 276, among other things. The container folders 276 may each include container IaC code 277-1, which is one example of new IaC code 171. The output IaC code file 270 may also include other new IaC code 171 (not illustrated in FIG. 3), as well as preexisting IaC code 172 (not illustrated in FIG. 3). Each container folder 276 corresponds to a particular container which is to be deployed as part of the overall infrastructure deployment, and the corresponding container IaC code 277 stored in the folder is IaC code which will cause the deployment of the corresponding container when executed. For example, the container IaC code 277 may be written in Docker Compose language.

The configuration file 274 specifies an execution order 275 in which the container IaC code 277 is to be executed, or in other words an order in which the corresponding containers are to be deployed. The configuration file 274 may be a text file, a CSV file, an XML file, or any other type of file which can specify an order of execution. In some examples, the configuration file 274 provides the execution order 275 as an ordered list of the names of the container folders 276. In some examples, the configuration file 274 provides the execution order 275 as an ordered list of the names of the containers. In some examples, the names of the container folders 276 are the same as the names of the containers they represent, in which case the two previously mentioned alternatives may be identical.

In some examples, the intermediate representation 230 may include component dependency information 234, in addition to the other information already described above. In some examples, the code generator subsystem 140 (e.g., via a Docker Compose code generator plugin 141), may determine the proper execution order 275 and generate the config file 274 based on the component dependency information 234. In some examples, component dependency information 234 may be included for certain containers that are dependent upon other containers. A given container “A” depends on another container “B” if the first container A needs the container B to be deployed prior to the container A being deployed in order to allow for full or error free deployment or operation of container A. In some examples in which the intermediate representation 230 is represented in JSON format as a series of steps for each infrastructure object, steps corresponding to container objects may include one or more key/value pairs specifying dependencies of the corresponding container (in addition to the other key/value pairs described herein).

In some examples, the code generator subsystem 140 (e.g., via a Docker Compose code generator plugin 141), may determine the proper execution order 275 and generate the config file 274 for a given intermediate representation 130 by generating and analyzing a Direct Acyclic Graph (DAG) 180 based on the component dependency information 234 in the given intermediate representation 130. FIG. 4 illustrates one hypothetical example of a DAG 180 which might be generated by the subsystem 140. Each DAG 180 comprises a series of nodes 181 and edges 182 connecting nodes 181 together in a directional manner. In FIG. 4, the nodes 181 are depicted as circles and the directional edges 182 are depicted as arrows. In the DAG 180, each node 181 corresponds to a container of a deployment, with these containers being given numerical identifiers in FIGS. 3-5 for ease of understanding. In the DAG 180, the directional edges 182 represent dependencies between containers, with the container represented by the node 181 at the origin of the arrow 182 being dependent upon the container represented by the node 181 at the terminus of the arrow 182. Thus, in the example of FIG. 4, the container 6 is dependent upon container 3, container 3 is dependent upon container 8, container 2 is also dependent upon container 8, container 8 is dependent upon container 5, container 5 is dependent upon both containers 1 and 7, container 10 is dependent upon container 4, and containers 7, 1, 4, and 9 are not dependent upon any other containers. In FIG. 4, a relatively complicated deployment comprising many containers with many layers of dependency is depicted, but it should be understood that any number of containers may be present and they may have any dependency arrangement.

Once the DAG 180 has been generated for a given intermediate representation 130, the code generator subsystem 140 (e.g., Docker Compose code generator plugin 141) may determine the proper execution order 275 by traversing the DAG 180. As used herein, traversing the DAG 180 comprises a process in which the subsystem 140 visits each node 181 of the DAG 180 in turn, following traversal rules explained below. As each node 181 is visited, the subsystem 140 records the name of the corresponding container in current position in the execution order 275, with the position in the execution order being incremented with each node 181 visited, i.e., the name of the first node 181 visited is recorded in the first position in the execution order 275, the name of the second node 181 visited is recorded in the second position in the execution order 275, and so on. Thus, once the entire DAG 180 has been traversed, the execution order 275 includes the names of all the containers listed in the same order in which the nodes 181 were visited.

The traversal rules will be described in relation to FIG. 5, which illustrates traversal of the DAG 180 of FIG. 4. In FIG. 5, an order of traversal is indicated by numbers adjacent to the nodes 181, whereas phases of the traversal are indicated by roman numerals.

During traversal of the DAG 180, each node 181 is visited only once. Moreover, the nodes 181 are visited in reverse order of dependency, such that a node 181 is visited only after all the nodes 181 upon which it depends have already been visited. More specifically, the traversal of the DAG 180 may begin in a first phase (phase I) by first visiting each node 181 which does not depend upon any other node 181, meaning a node 181 that does not have any directed edge 182 which originates at that node 181. For example, as shown in FIG. 5, the nodes 181 representing the containers 7, 1, 4, and 9 may be visited in phase I. In FIG. 5, the node 181 representing container 7 is visited first, and therefore container 7 is listed first in the execution order 275. Similarly, the nodes 181 of containers 1, 4, and 9, are visited second, third, and fourth, respectively, and therefore the names of these containers are listed in the second, third, and fourth places, respectively, in the execution order 275. Note that these nodes 181 representing containers 7, 1, 4, and 9 could have been visited in any order relative to one another in phase I (as long as they are all visited before moving on to the next phase), and the order listed above is merely one example. In other words, within a given phase, the nodes 181 which are to be visited within that same given phase may be visited in any desired order. Accordingly, there may be multiple possible valid execution orders 275 that could be generated from a given DAG 180, but not all execution orders 275 would be valid.

In a next phase (e.g., phase II), each node 181 which depends on any of the nodes 181 visited in the previous phase (e.g., phase I) is visited next. In the example of FIG. 5, the nodes 181 for containers 5 and 10 each depend from at least one of the nodes 181 visited in phase 1, and therefore these nodes 181 are the next visited. In the example of FIG. 5, the node 181 of container 5 is visited fifth and the node 181 of container 10 is visited sixth, and thus the names of these containers are listed in the fifth and sixth places, respectively, in the execution order 275. Note that these nodes 181 of containers 5 and 10 could have been visited in the opposite order, if desired, so long as they are both visited before moving on to the next phase.

This same process may be repeated over again in subsequent phases until all of the nodes 181 have been visited. Specifically, in each new phase, each node 181 which depends on any of the nodes 181 visited in the previous phase is visited in the current phase. This ends after all of the nodes 181 have been visited. The number of phases that are required may vary depending on the particular dependencies of any given deployment. In FIG. 5, the node 181 of container 8 is visited in phase III, the nodes 181 of containers 3 and 2 are visited in phase IV, and the node 181 of container 6 is visited in phase V, whereupon the traversal ends as all nodes 181 have been visited. As noted, the names of the containers are listed in the execution order 275 in the same order which the nodes 181 were traversed. In this manner, the subsystem 140 can determine the proper execution order by analyzing (traversing) the DAG 180.

The configuration file 274 and execution order 275 thereof are described above in relation to containers because this is a common case in which they may be useful, but it should be understood that the configuration file 274 and execution order 275 could also be used in relation to other types of infrastructure if desired. For example, in some implementations the configuration file 274 may be provided in the output IaC code file 170 whenever infrastructure in the intermediate representation 130 has execution order dependencies.

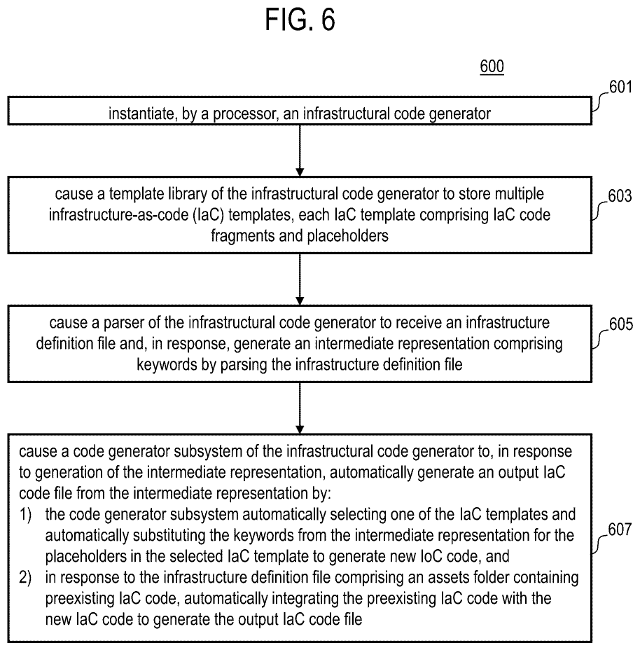

Turning to FIG. 6, a method 600 will now be described. The method 600 may be performed by, or using, an infrastructural code generator, such as the ICG 110 described above.

In step 601, a processor instantiates an infrastructural code generator (ICG).

In step 603, a template library of the ICG is caused to store multiple IaC templates. Each of the IaC templates comprises IaC code fragments and placeholders, as described above.

In step 605, a parser of the ICG is caused to receive an infrastructure definition file and to, in response, generate an intermediate representation based on the same. The intermediate representation comprises keywords obtained by parsing the infrastructure definition file.

In step 607, a code generator subsystem of the ICG is to, in response to generation of the intermediate representation, automatically generate an output IaC code file from the intermediate representation. More specifically, the output IaC code file is generated by: (1) the code generator subsystem automatically selecting one of the IaC templates and automatically substituting the keywords from the intermediate representation for the placeholders in the selected IaC template to generate new IaC code, and (2) in response to the infrastructure definition file comprising an assets folder containing preexisting IaC code, automatically integrating the preexisting IaC code with the new IaC code to generate the output IaC code file.

FIG. 7 illustrates an example non-transitory computer readable medium 700 storing infrastructural code generator instructions 707. The infrastructural code generator instructions 707 are machine readable instructions executable by a processor. The infrastructural code generator instructions 707 are one example of the instructions 107 from FIG. 1, and are configured to, when executed by the processor, instantiate an infrastructural code generator, such as the ICG 110 described above, and to cause the ICG to perform the operations described herein.

In particular, the infrastructural code generator instructions 707 may comprise controller instructions 791 configured to, when executed, cause a controller to be instantiated, such as the controller 115 in some examples. The instructions 791 may be configured to cause the controller to perform any of the operations described above in relation to controller 115.

The infrastructural code generator instructions 707 may also comprise parser instructions 792 configured to, when executed, cause a parser to be instantiated, such as the parser 120 in some examples. The instructions 792 may be configured to cause the parser to parse an infrastructure definition file and generate therefrom an intermediate representation, as described above in relation to parser 120. The instructions 792 may also be configured to cause the parser to perform any of the other operations described above in relation to parser 120.

The infrastructural code generator instructions 707 may also comprise template library instructions 793 configured to, when executed, cause a template library to be instantiated, such as the template library 150 in some examples. The instructions 793 may be configured to cause the template library to store IaC templates, as described above in relation to template library 150.

The infrastructural code generator instructions 707 may also comprise code generation subsystem instructions 794 configured to, when executed, cause a code generation subsystem to be instantiated, such as the code generation subsystem 140 in some examples. The instructions 794 may be configured to cause the code generation subsystem to generate an output IaC code file based on the templates in the template library and the intermediate representation generated by the parser, as described above in relation to code generation subsystem 140. The instructions 794 may also be configured to cause the code generation subsystem to perform any of the other operations described above in relation to code generation subsystem 140. In particular, in some examples, the instructions 794 may include code generation plugin instructions 795 for multiple different plugins (only one set of such instructions 795 is illustrated, but multiple may be present), with each such plugin corresponding to a different IaC tool/language. Each set of code generation plugin instructions 795 may be configured to instantiate a corresponding plugin configured to perform any of the operations described above in relation to plugins 141.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a”, “an”, and “the” are intended to include the plural forms as well, unless the context indicates otherwise. Moreover, the terms “comprises”, “comprising”, “includes”, and the like specify the presence of stated features, steps, operations, elements, and/or components but do not preclude the presence or addition of one or more other features, steps, operations, elements, components, and/or groups. Components described as coupled may be electronically or mechanically directly coupled, or they may be indirectly coupled via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that functions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}”.

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within +1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the invention disclosed herein. It is intended that the specification and examples be considered as exemplary only, with the following claims being entitled to their fullest breadth, including equivalents, under the applicable law.

What is claimed is:

1. A computing system comprising:
a processor; and
a storage device storing instructions executable by the processor and configured to cause the processor to instantiate an infrastructural code generator comprising:
a template library storing multiple infrastructure-as-code (IaC) templates, each IaC template comprising IaC code fragments and placeholders;
a parser configured to, in response to receiving an infrastructure definition file, generate an intermediate representation comprising keywords by parsing the infrastructure definition file; and
a code generator subsystem configured to, in response to generation of the intermediate representation, generate an output IaC code file from the intermediate representation by:
selecting at least one of the IaC templates and substituting the keywords from the intermediate representation for the placeholders in the selected IaC template to generate new IaC code, and
in response to the infrastructure definition file comprising an assets folder containing preexisting IaC code, integrating the preexisting IaC code with the new IaC code to generate the output IaC code file.

2. The system of claim 1,
wherein the code generator subsystem of the infrastructural code generator comprises multiple code generator plug-ins corresponding respectively to different IaC tools that respectively utilize different IaC languages;
wherein the infrastructural code generator comprises a controller configured to, in response to generation of the intermediate representation, select one of the code generator plug-ins to generate IaC code from the intermediate representation; and
wherein each of the code generator plug-ins is configured to, in response to being selected, generate the output IaC code file from the intermediate representation in one of the IaC languages corresponding to the respective IaC tool.

3. The system of claim 2,
wherein the parser is configured to include in the intermediate representation IaC language information specifying an IaC language, and
wherein the controller is configured to select one of the code generator plug-ins to generate IaC code based on the IaC language information in the intermediate representation.

4. The system of claim 2,
wherein each of the IAC templates comprises IaC code fragments in a corresponding IaC language of the IaC languages.

5. The system of claim 2,
wherein each of the code generator plug-ins is configured to, in response to being selected, select one of the IaC templates based on the intermediate representation.

6. The system of claim 5,
wherein the parser is configured to include in the intermediate representation target platform information specifying a target platform for deployment of infrastructure, and
wherein each of the code generator plug-ins is configured to, in response to being selected, select one of the IaC templates based on the target platform information specified in the intermediate representation.

7. The system of claim 2,
wherein the IaC tools include Terraform, Ansible, and Docker Compose.

8. The system of claim 1,
wherein the parser is configured to include in the intermediate representation:
target platform information specifying a target platform for deployment of infrastructure;
component type information specifying component types for components of the infrastructure to be deployed; and
IaC language information specifying an IaC language for the new IaC code.

9. The system of claim 8,
wherein the code generator subsystem is configured to, in response to generation of the intermediate representation, select one of the IaC templates based on the target platform information, the infrastructure type information, and the IaC language information.

10. The system of claim 8,
wherein the parser is configured to include in the intermediate representation operating system information specifying an operating system to be used with the infrastructure, and
wherein the code generator subsystem is configured to, in response to generation of the intermediate representation, select one of the IaC templates based on the target platform information, the infrastructure type information, the IaC language information, and the operating system information.

11. The system of claim 1,
wherein infrastructure definition file comprises a model of an infrastructure modeling language.

12. The system of claim 11,
wherein the infrastructure modeling language is the DevSecOps Modelling Language (DOML).

13. The system of claim 1,
wherein the code generator subsystem is configured to generate, in the output IaC code file, a configuration file specifying an order of execution of portions of the IaC code in the output IaC code file.

14. The system of claim 13,
wherein the parser is configured to include in the intermediate representation dependency information specifying dependencies between infrastructure objects, and
wherein the code generator subsystem is configured to determine the order of execution for the configuration file based on the dependency information.

15. The system of claim 14,
wherein the code generator subsystem is configured to determine the order of execution for the configuration file based on the dependency information by creating a graph structure mapping the infrastructure objects as graph nodes and their dependencies as graph edges, traversing the graph, and listing names of the infrastructure objects in the configuration file in the order that the corresponding nodes in the graph are traversed.

16. A non-transitory computer readable medium storing instructions executable by a processor and configured to cause the processor to instantiate an infrastructural code generator comprising:
a template library storing multiple infrastructure-as-code (IaC) templates, each IaC template comprising IaC code fragments and placeholders;
a parser configured to, in response to receiving an infrastructure definition file, generate an intermediate representation comprising keywords by parsing the infrastructure definition file; and
a code generator subsystem configured to, in response to generation of the intermediate representation, generate an output IaC code file from the intermediate representation by:
selecting one of the IaC templates and substituting the keywords from the intermediate representation for the placeholders in the selected IaC template to generate new IaC code, and
in response to the infrastructure definition file comprising an assets folder containing preexisting IaC code, integrating the preexisting IaC code with the new IaC code to generate the output IaC code file.

17. The non-transitory computer readable medium of claim 16,
wherein the code generator subsystem of the infrastructural code generator comprises multiple code generator plug-ins corresponding respectively to different IaC tools that respectively utilize different IaC languages;
wherein the infrastructural code generator comprises a controller configured to, in response to generation of the intermediate representation, select one of the code generator plug-ins to generate IaC code from the intermediate representation; and
wherein each of the code generator plug-ins is configured to, in response to being selected, generate the output IaC code file from the intermediate representation in a corresponding one of the IaC languages.

18. The computer readable medium of claim 17,
wherein infrastructure definition file comprises DevSecOps Modelling Language (DOML) model.

19. The computer readable medium of claim 17,
wherein the code generator subsystem is configured to generate, in the output IaC code file, a configuration file specifying an order of execution of portions of the IaC code in the output IaC code file.

20. A method comprising:
instantiating, by a processor, an infrastructural code generator;
causing a template library of the infrastructural code generator to store multiple infrastructure-as-code (IaC) templates, each IaC template comprising IaC code fragments and placeholders;
causing a parser of the infrastructural code generator to receive an infrastructure definition file and, in response, generate an intermediate representation comprising keywords by parsing the infrastructure definition file; and
causing a code generator subsystem of the infrastructural code generator to, in response to generation of the intermediate representation, automatically generate an output IaC code file from the intermediate representation by:
the code generator subsystem automatically selecting one of the IaC templates and automatically substituting the keywords from the intermediate representation for the placeholders in the selected IaC template to generate new IaC code, and
in response to the infrastructure definition file comprising an assets folder containing preexisting IaC code, automatically integrating the preexisting IaC code with the new IaC code to generate the output IaC code file.
